(19) United States
(12) Patent Application Publication
(10) Pub. No.: US 2026/0200301 A1
(43) Pub. Date: Jul. 16, 2026

(54) VEHICLE BODY CONNECTING STRUCTURE

(71) Applicant: Honda Motor Co., Ltd., Tokyo (JP)

(72) Inventors: Eiji HIRANO, Saitama (JP); Yasunori WATANABE, Saitama (JP)

(73) Assignee: Honda Motor Co., Ltd., Tokyo (JP)

(21) Appl. No.: 19/372,326

(22) Filed: Oct. 29, 2025

(30) Foreign Application Priority Data
Jan. 14, 2025 (CN) 202510056825.3

(51) Int. Cl. B60J 5/04

(52) U.S. Cl. CPC B60J 5/0468

(57) ABSTRACT

A vehicle body connecting structure is provided. The vehicle body connecting structure is adapted to be disposed on a vehicle body structure having a vehicle door and a vehicle body and includes a protruding component disposed on the vehicle door and protruding toward the vehicle body, a receiving component disposed on the vehicle body and receiving the protruding component, and an installation component disposed on the vehicle body and on which the receiving component is installed. The receiving component includes a main fixed portion non-displaceably fixed to the installation component relative to the vehicle body, a temporary holding portion displaceably engaged with the installation component relative to the installation component, and an abutting portion abutting against the protruding component.

### CROSS-REFERENCE TO RELATED APPLICATION

This application claims the priority benefit of China application serial no. 202510056825.3, filed on January 14, 2025. The entirety of the above-mentioned patent application is hereby incorporated by reference herein and made a part of this specification.

### BACKGROUND

### Technical Field

The disclosure relates to a vehicle body connecting structure.

### Description of Related Art

In recent years, in order to ensure access to affordable, reliable, sustainable, and advanced energy for more people, research and development on lightweight vehicles that contribute to energy efficiency has been conducted. However, in the technology related to vehicle lightweighting, alignment of components during a connecting process of a vehicle body connecting structure remains an issue.

For example, the prior art (for example, Japanese Patent Publication No. 2014-162239) discloses a vehicle body connecting structure in which a protrusion is provided on a vehicle door and a recess for inserting the protrusion is provided on a vehicle body, so as to connect the vehicle door and the vehicle body. Furthermore, the prior art also discloses a tolerance range of the size of the recess in the up-down direction that may match the size of the protrusion in the up-down direction. However, since the recess is fixed to the vehicle body, if there is a tolerance of the vehicle door relative to the vehicle body, there is a possibility that the protrusion may not fit into the recess. If the protrusion is forcibly inserted into the recess, a large load is applied to the recess. Alternatively, the tolerance of the protrusion and the vehicle door need to be precisely controlled to ensure a successful match. Thus, it is necessary to improve such a vehicle body connecting structure and connection means.

The disclosure aims to achieve a vehicle body connecting structure that improves connection quality through absorbing tolerance and has a lightweight and strong structure, thereby contributing to energy efficiency.

### SUMMARY

The disclosure provides a vehicle body connecting structure adapted to be disposed on a vehicle body structure having a vehicle door and a vehicle body and including a protruding component disposed on the vehicle door and protruding toward the vehicle body, a receiving component disposed on the vehicle body and receiving the protruding component, and an installation component disposed on the vehicle body and on which the receiving component is installed. The receiving component includes a main fixed portion non-displaceably fixed to the installation component relative to the vehicle body, a temporary holding portion displaceably engaged with the installation component relative to the installation component, and an abutting portion abutting against the protruding component.

### BRIEF DESCRIPTION OF THE DRAWINGS

FIG. 1 is a schematic cross-sectional view of a vehicle body connecting structure in a short-side direction before assembly according to an embodiment of the disclosure.

FIG. 2 is a schematic cross-sectional view of the vehicle body connecting structure shown in FIG. 1 in the short-side direction after assembly.

FIG. 3 is a schematic cross-sectional view of the vehicle body connecting structure shown in FIG. 2 in a longitudinal direction after assembly.

FIG. 4 is a schematic top view of the vehicle body connecting structure shown in FIG. 2 after assembly.

### DESCRIPTION OF THE EMBODIMENTS

The disclosure provides a vehicle body connecting structure, which can improve connection quality through absorbing tolerance and has a light and strong structure.

The disclosure provides a vehicle body connecting structure adapted to be disposed on a vehicle body structure having a vehicle door and a vehicle body and including a protruding component disposed on the vehicle door and protruding toward the vehicle body, a receiving component disposed on the vehicle body and receiving the protruding component, and an installation component disposed on the vehicle body and on which the receiving component is installed. The receiving component includes a main fixed portion non-displaceably fixed to the installation component relative to the vehicle body, a temporary holding portion displaceably engaged with the installation component relative to the installation component, and an abutting portion abutting against the protruding component.

In an embodiment of the disclosure, the protruding component is configured in a flat plate shape. The receiving component abuts against the protruding component with the abutting portion in a short-side direction of the protruding component and is spaced apart from the protruding component without abutting against the protruding component in a longitudinal direction of the protruding component.

In an embodiment of the disclosure, the receiving component is engaged with the installation component with the temporary holding portion in the longitudinal direction of the protruding component.

In an embodiment of the disclosure, the receiving component is fixed to the installation component with the main fixed portion in the longitudinal direction of the protruding component.

In an embodiment of the disclosure, the receiving component has an insertion groove for the protruding component to be inserted. The insertion groove has an opening portion located on an outer surface of the receiving component and a bottom portion extending toward an inner side of the receiving component relative to the opening portion. The abutting portion is disposed at the bottom portion of the insertion groove. A part of the insertion groove closer to the opening portion than the abutting portion is spaced apart from the protruding component and does not abut against the protruding component.

In an embodiment of the disclosure, the opening portion of the insertion groove is provided with a guiding portion expanding toward an outer side of the insertion groove.

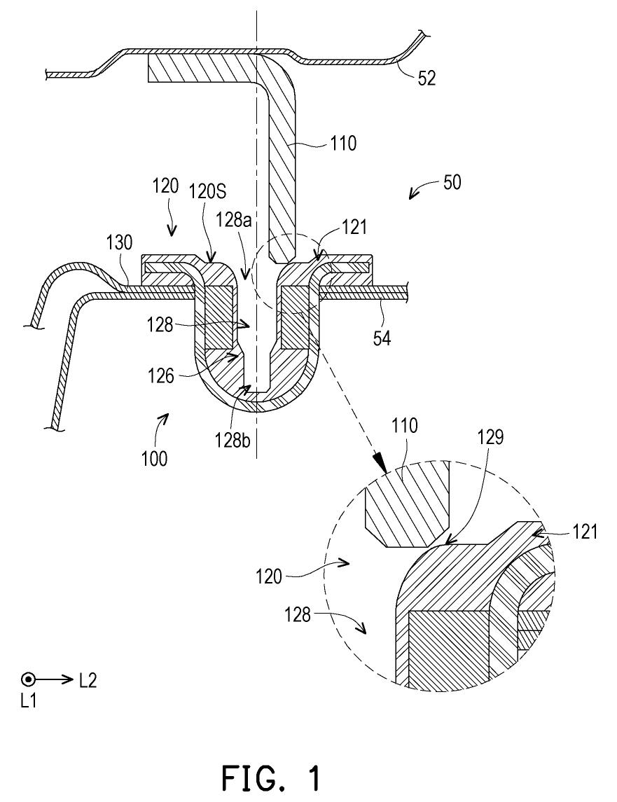

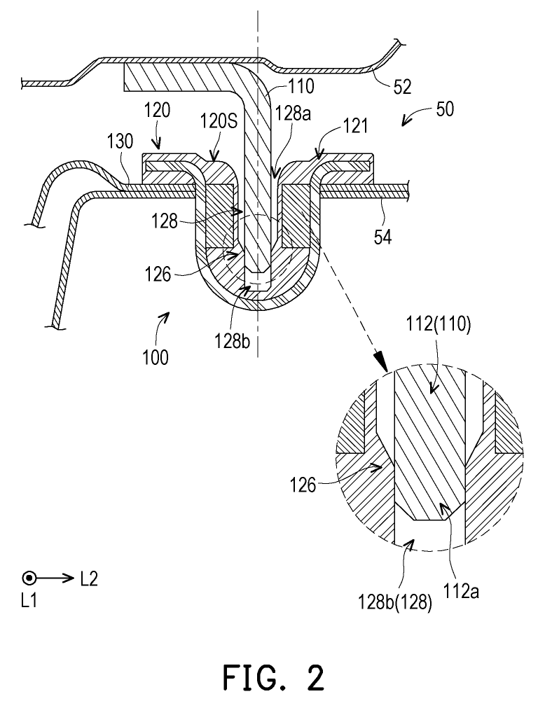

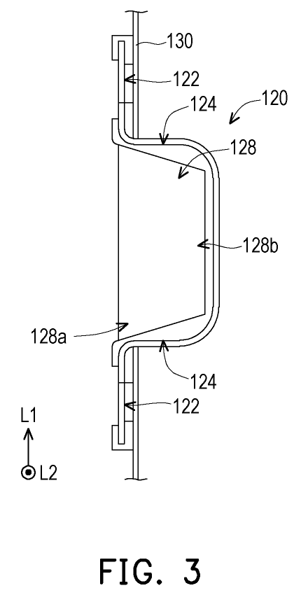

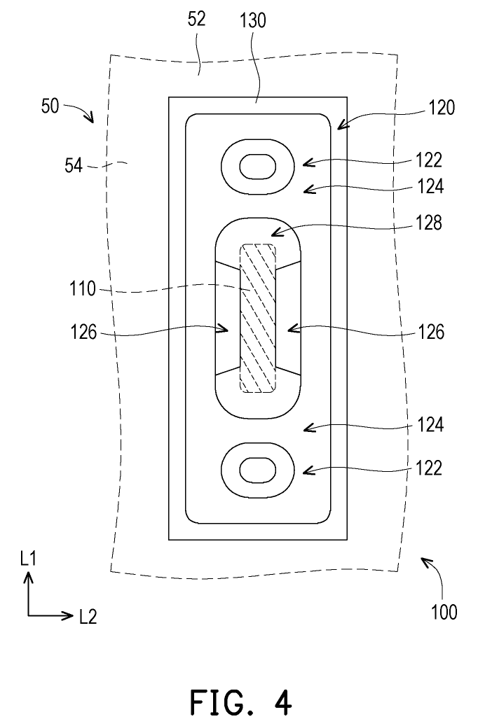

Reference will now be made in detail to exemplary embodiments of the disclosure, and examples of the exemplary embodiments are illustrated in the drawings. FIG. 1 is a schematic cross-sectional view of a vehicle body connecting structure in a short-side direction before assembly according to an embodiment of the disclosure. FIG. 2 is a schematic cross-sectional view of the vehicle body connecting structure shown in FIG. 1 in the short-side direction after assembly. FIG. 3 is a schematic cross-sectional view of the vehicle body connecting structure shown in FIG. 2 in a longitudinal direction after assembly. FIG. 4 is a schematic top view of the vehicle body connecting structure shown in FIG. 2 after assembly. The specific structure of a vehicle body connecting structure 100 of the embodiment will be described below with reference to FIG. 1 to FIG. 4. However, this is only one example of the disclosure and the disclosure is not limited thereto.

Please refer to FIG. 1 to FIG. 4. In the embodiment, the vehicle body connecting structure 100 is adapted to be disposed on a vehicle body structure 50 having a vehicle door 52 and a vehicle body 54 to connect the vehicle door 52 and the vehicle body 54. The vehicle body connecting structure 100 includes a protruding component 110, a receiving component 120, and an installation component 130. The protruding component 110 is disposed on the vehicle door 52 and protrudes toward the vehicle body 54. The receiving component 120 is disposed on the vehicle body 54 and receives the protruding component 110. The installation component 130 is disposed on the vehicle body 54, and the receiving component 120 is connected thereto. The receiving component 120 includes a main fixed portion 122 non-displaceably fixed to the installation component 130 relative to the vehicle body 54, a temporary holding portion 124 displaceably engaged with the installation component 130 relative to the installation component 130, and an abutting portion 126 abutting against the protruding component 110.

Specifically, in the embodiment, as shown in FIG. 1 to FIG. 4, the protruding component 110 is disposed on the vehicle door 52 and protrudes toward the outer side (the side of the vehicle body 54), so that when an end portion of the vehicle door 52 provided with the protruding component 110 moves to an end portion of the vehicle body 54 provided with the receiving component 120, the protruding component 110 may protrude toward the vehicle body 54 and be inserted into the receiving component 120. The protruding component 110 is, for example, a part of the vehicle door 52 or may also be an independent structure connected to the vehicle door 52. Furthermore, the receiving component 120 is disposed on the vehicle body 54 through the installation component 130 and is recessed toward the inner side (the side of the vehicle body 54), so that when the end portion of the vehicle door 52 provided with the protruding component 110 moves to the end portion of the vehicle body 54 provided with the receiving component 120, the protruding component 110 may be correspondingly received (for example, the protruding component 110 is inserted into the receiving component 120). The installation component 130 is, for example, a part of the vehicle body 54 or may also be an independent structure installed to the vehicle body 54, and the receiving component 120 is, for example, an independent structure installed to the vehicle body 54 through the installation component 130. In this way, in the case where the end portion of the vehicle door 52 provided with the protruding component 110 moves to the end portion of the vehicle body 54 provided with the receiving component 120 (for example, the vehicle door 52 is closed relative to the vehicle body 54), the protruding component 110 disposed on the vehicle door 52 is inserted into the receiving component 120 disposed on the vehicle body 54 (that is, the receiving component 120 receives the protruding component 110), so that the end portion of the vehicle door 52 provided with the protruding component 110 is connected to the end portion of the vehicle body 54 provided with the receiving component 120.

Furthermore, in the embodiment, as shown in FIG. 1 to FIG. 4, the receiving component 120 is non-displaceably fixed to the installation component 130 through, for example, a fixing bolt, etc. penetrating the main fixed portion 122 (as shown in FIG. 4). Accordingly, the receiving component 120 is displaceably engaged with the installation component 130 through, for example, an engagement claw, etc. penetrating the temporary holding portion 124 (as shown in FIG. 4). Temporary holding means that relative displacement is possible in the case of external force. In this way, the position of the receiving component 120 may be preset through the main fixed portion 122, and the protruding component 110 is preset at a position corresponding to the receiving component 120 on the vehicle door 52, so that in the case where the end portion of the vehicle door 52 provided with the protruding component 110 moves to the end portion of the vehicle body 54 provided with the receiving component 120, the protruding component 110 is inserted into the receiving component 120 to connect the vehicle door 52 to the vehicle body 54. In addition, in the case where the protruding component 110 is not aligned with the receiving component 120 due to the tolerance of the vehicle door 52, etc. (as shown in FIG. 1), the receiving component 120 may be pushed through the protruding component 110 and is spontaneously displaced relative to the installation component 130 with the temporary holding portion 124 (as shown by the arrow in FIG. 1), thereby absorbing the tolerance of the vehicle door 52 and spontaneously aligning, so that the protruding component 110 is smoothly inserted into the temporary holding portion 124 of the receiving component 120 and is positioned through abutting against the abutting portion 126 in the temporary holding portion 124 (as shown in FIG. 2).

Through the above disposition, in the vehicle body connecting structure 100 of the embodiment, the receiving component 120 is non-displaceably fixed to the installation component 130 relative to the vehicle body 54 through the main fixed portion 122, is displaceably engaged with the installation component 130 relative to the installation component 130 through the temporary holding portion 124, and abuts against the protruding component 110 through the abutting portion 126. In this way, the protruding component 110 may perform a connecting action according to the position of the receiving component 120 preset through the main fixed portion 122. In addition, the position of the receiving component 120 may be finely adjusted through the temporary holding portion 124 to absorb the misalignment between the protruding component 110 and the receiving component 120 due to the tolerance of the vehicle door 52, so that the protruding component 110 may be spontaneously aligned and smoothly inserted into the receiving component 120 without damaging the receiving component 120. In particular, the vehicle body connecting structure 100 of the embodiment has a lightweight and strong structure through the above configuration, thereby reducing the amount of material used, reducing the weight of the vehicle body, and reducing fuel consumption and power consumption. Accordingly, the vehicle body connecting structure 100 can improve connection quality through absorbing tolerance and has a lightweight and strong structure.

Furthermore, in the embodiment, as shown in FIG. 1 and FIG. 2, the receiving component 120 includes an insertion groove 128 for the protruding component 110 to be inserted. The insertion groove 128 has an opening portion 128a located on an outer surface 120S of the receiving component 120 and a bottom portion 128b extending toward the inner side of the receiving component 120 relative to the opening portion 128a. The abutting portion 126 is disposed at the bottom portion 128b of the insertion groove 128, and a part of the insertion groove 128 closer to the opening portion 128a than the abutting portion 126 is spaced apart from the protruding component 110 and does not abut against the protruding component 110. Furthermore, the opening portion 128a of the insertion groove 128 is provided with a guiding portion 129 expanding toward the outer side of the insertion groove 128. As an example, the insertion groove 128 of the receiving component 120 is configured as a strip-shaped groove capable of receiving the protruding component 110. For example, the width of the insertion groove 128 is greater than the width of the protruding component 110 (as shown in FIG. 1 and FIG. 2), so that the protruding component 110 may be inserted into the insertion groove 128. Furthermore, the insertion groove 128 is provided with the abutting portion 126 at the bottom portion 128b to reduce the width, and a part of the insertion groove 128 other than the abutting portion 126 maintains the original width (as shown in FIG. 1 and FIG. 2). In contrast, an edge portion of the opening portion 128a of the insertion groove 128 is provided with a chamfer or an inclined surface to form the guiding portion 129, so that the width around the opening portion 128a may be expanded.

Through the above disposition, in the embodiment, as shown in FIG. 1 and FIG. 2, during the process of inserting the protruding component 110 into the insertion groove 128 of the receiving component 120, A top end 112a of an insertion end portion 112 of the protruding component 110 may be easily inserted into the insertion groove 128 through the opening portion 128a under the guidance of the guiding portion 129 (the state as shown in FIG. 1 and FIG. 2). Furthermore, after the protruding component 110 is inserted into the insertion groove 128 of the receiving component 120, the top end 112a of the insertion end portion 112 of the protruding component 110 abuts against the abutting portion 126, and the remaining part of the insertion end portion 112 of the protruding component 110 is spaced apart from an inner side wall of the insertion groove 128. As can be seen from this, even if there is a large deviation between the insertion end portion 112 of the protruding component 110 and the opening portion 128a of the insertion groove 128, the protruding component 110 may be reliably aligned through the guidance of the guiding portion 129. Furthermore, the protruding component 110 contacts only the abutting portion 126, that is, a part of the bottom portion 128b of the insertion groove 128, so a high insertion load due to the overall contact between the protruding component 110 and the insertion groove 128 in the depth direction may be prevented. Also, while performing the fine adjustment and the alignment, an insertion load of the protruding component 110 inserted into the insertion groove 128 when the vehicle door 52 is opened and closed during daily use may be suppressed. However, the disclosure does not limit the specific structure, etc. of the receiving component 120, which may be adjusted according to requirements.

Furthermore, in the embodiment, as shown in FIG. 3 and FIG. 4, the protruding component 110 is configured in a flat plate shape. Here, the cross section of the protruding component 110 is configured as a rectangle, but the surface thereof is not limited to being a flat surface and may also be configured as a curved surface with a slight curvature. Accordingly, the insertion groove 128 of the receiving component 120 is expanded corresponding to the shape of the protruding component 110 and is configured as a strip-shaped groove capable of receiving the protruding component 110. Furthermore, the receiving component 120 abuts against the protruding component 110 with the abutting portion 126 (for example, disposed at the bottom portion 128b of the insertion groove 128) in a short-side direction L2 of the protruding component 110 and is spaced apart from the protruding component 110 without abutting against the protruding component 110 in a longitudinal direction L1 of the protruding component 110. As an example, the abutting portion 126 is provided as a pair of strip-shaped ribs spaced apart in the short-side direction L2 of the insertion groove 128 and does not extend to a region in the longitudinal direction L1 of the insertion groove 128. Therefore, after the protruding component 110 is inserted into the insertion groove 128 of the receiving component 120, the receiving component 120 abuts against two opposite side surfaces in the short-side direction L2 of the protruding component 110 with the pair of strip-shaped ribs serving as the abutting portion 126 in the short-side direction L2, but does not abut against two opposite end portions in the longitudinal direction L1 of the protruding component 110. In this way, the receiving component 120 may stably hold the protruding component 110 in the short-side direction L2 while allowing the position of the protruding component 110 to shift in the longitudinal direction L1, so that the protruding component 110 may be more easily aligned with the receiving component 120, thereby improving connection quality. However, the disclosure does not limit the specific structures, etc. of the protruding component 110 and the receiving component 120, which may be adjusted according to requirements.

In addition, in the embodiment, as shown in FIG. 3, the receiving component 120 is engaged with the installation component 130 with the temporary holding portion 124 in the longitudinal direction L1 of the protruding component 110, and the receiving component 120 is fixed to the installation component 130 with the main fixed portion 122 in the longitudinal direction L1 of the protruding component 110. As an example, the receiving component 120 includes a main body 121 and the insertion groove 128 disposed in a substantially middle part of the main body 121. The size of the main body 121 of the receiving component 120 in the longitudinal direction L1 is greater than the size in the short-side direction L2, so as to form a substantially rectangular structure with a relatively long length. The main body 121 at least includes the main fixed portion 122 and the temporary holding portion 124. In this way, an end portion of the receiving component 120 in the longitudinal direction L1 may be temporarily held on the vehicle body 54 through the temporary holding portion 124 (for example, in combination with the engagement claw). Compared with temporary holding only in the short-side direction L2, the receiving component 120 may be prevented from significantly moving in a temporarily held state. Furthermore, since the abutting portion 126 abuts against the protruding component 110 in the short-side direction L2, the temporary holding portion 124 disposed in the longitudinal direction L1 may be relatively displaced through sliding in the short-side direction L2, so there is no unnecessary movement during use. Furthermore, the end portion of the receiving component 120 in the longitudinal direction L1 may be fixed to the installation component 130 through the main fixed portion 122 (for example, in combination with the fixing bolt), and main fixing may be performed at a part near the temporary holding portion 124, so as to improve the operability of the main fixing. However, the disclosure does not limit the fixing position, the fixing manner, etc. of the receiving component 120 on the installation component 130, which may be adjusted according to requirements.

In summary, in the vehicle body connecting structure of the disclosure, the receiving component is non-displaceably fixed to the installation component relative to the vehicle body through the main fixed portion, is displaceably engaged with the installation component relative to the installation component through the temporary holding portion, and abuts against the protruding component through the abutting portion. In this way, the protruding component may perform the connecting action according to the position of the receiving component preset through the main fixed portion. In addition, the position of the receiving component may be finely adjusted through the temporary holding portion to absorb the misalignment between the protruding component and the receiving component due to the tolerance of the vehicle door, so that the protruding component may be spontaneously aligned and smoothly inserted into the receiving component without damaging the receiving component. In particular, the vehicle body connecting structure of the disclosure has a lightweight and strong structure through the above configuration, thereby reducing the amount of material used, reducing the weight of the vehicle body, and reducing fuel consumption and power consumption. Preferably, the receiving component abuts against the protruding component with the abutting portion in the short-side direction and is spaced apart from the protruding component without abutting against the protruding component in the longitudinal direction, so that the receiving component may stably hold the protruding component in the short-side direction while allowing the position of the protruding component to shift in the longitudinal direction. Accordingly, the vehicle body connecting structure can improve connection quality through absorbing tolerance and has a lightweight and strong structure.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A vehicle body connecting structure, adapted to be disposed on a vehicle body structure having a door and a vehicle body, comprising:
a protruding component, disposed on the vehicle door and protruding toward the vehicle body;
a receiving component, disposed on the vehicle body and receiving the protruding component; and
an installation component, disposed on the vehicle body and on which the receiving component is installed, wherein
the receiving component comprises a main fixed portion non-displaceably fixed to the installation component relative to the vehicle body, a temporary holding portion displaceably engaged with the installation component relative to the installation component, and an abutting portion abutting against the protruding component.

2. The vehicle body connecting structure according to claim 1, wherein:
the protruding component is configured in a flat plate shape,
the receiving component abuts against the protruding component with the abutting portion in a short-side direction of the protruding component and is spaced apart from the protruding component without abutting against the protruding component in a longitudinal direction of the protruding component.

3. The vehicle body connecting structure according to claim 2, wherein:
the receiving component is engaged with the installation component with the temporary holding portion in the longitudinal direction of the protruding component.

4. The vehicle body connecting structure according to claim 3, wherein:
the receiving component is fixed to the installation component with the main fixed portion in the longitudinal direction of the protruding component.

5. The vehicle body connecting structure according to claim 1, wherein:
the receiving component has an insertion groove for the protruding component to be inserted,
the insertion groove has an opening portion located on an outer surface of the receiving component and a bottom portion extending toward an inner side of the receiving component relative to the opening portion,
the abutting portion is disposed at the bottom portion of the insertion groove, and
a part of the insertion groove closer to the opening portion than the abutting portion is spaced apart from the protruding component and does not abut against the protruding component.

6. The vehicle body connecting structure according to claim 2, wherein:
the receiving component has an insertion groove for the protruding component to be inserted,
the insertion groove has an opening portion located on an outer surface of the receiving component and a bottom portion extending toward an inner side of the receiving component relative to the opening portion,
the abutting portion is disposed at the bottom portion of the insertion groove, and
a part of the insertion groove closer to the opening portion than the abutting portion is spaced apart from the protruding component and does not abut against the protruding component.

7. The vehicle body connecting structure according to claim 3, wherein:
the receiving component has an insertion groove for the protruding component to be inserted,
the insertion groove has an opening portion located on an outer surface of the receiving component and a bottom portion extending toward an inner side of the receiving component relative to the opening portion,
the abutting portion is disposed at the bottom portion of the insertion groove, and
a part of the insertion groove closer to the opening portion than the abutting portion is spaced apart from the protruding component and does not abut against the protruding component.

8. The vehicle body connecting structure according to claim 4, wherein:
the receiving component has an insertion groove for the protruding component to be inserted,
the insertion groove has an opening portion located on an outer surface of the receiving component and a bottom portion extending toward an inner side of the receiving component relative to the opening portion,
the abutting portion is disposed at the bottom portion of the insertion groove, and
a part of the insertion groove closer to the opening portion than the abutting portion is spaced apart from the protruding component and does not abut against the protruding component.

9. The vehicle body connecting structure according to claim 5, wherein:
the opening portion of the insertion groove is provided with a guiding portion expanding toward an outer side of the insertion groove.

10. The vehicle body connecting structure according to claim 6, wherein:
the opening portion of the insertion groove is provided with a guiding portion expanding toward an outer side of the insertion groove.

11. The vehicle body connecting structure according to claim 7, wherein:
the opening portion of the insertion groove is provided with a guiding portion expanding toward an outer side of the insertion groove.

12. The vehicle body connecting structure according to claim 8, wherein:
the opening portion of the insertion groove is provided with a guiding portion expanding toward an outer side of the insertion groove.
